(19) United States
(12) Patent Application Publication
(10) Pub. No.: US 2004/0150798 A1
(43) Pub. Date: Aug. 5, 2004

(54) FIXING STRUCTURE FOR LIGHT VALVE

(76) Inventors: Chien-Ming Tsao, Miao- Li Hsien (TW); Yung-Chuan Tseng, Miao- Li Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,627

(22) Filed: Dec. 25, 2003

(30) Foreign Application Priority Data
Jan. 21, 2003 (TW) 092201419

(51) Int. Cl. G03B 21/22

(52) U.S. Cl. 353/75

(57) ABSTRACT

A fixing structure for a light valve is installed on a projection apparatus having a container. The fixing structure comprises a connector and a circuit broad. The light valve is inserted into the connector, and the connector is fixed to the container by utilizing the fixing plates or adhesive. The printed circuit broad connects with the connector and is screwed to the projection apparatus by screwing devices. Thus, the light valve and the circuit broad have individually fixing structures. As disassembling the circuit broad for maintaining, the light valve can't be dismantled or removed. Hence, the fixing structure prevents damaging the light valve so that the projection apparatus has optimum performance.

### BACKGROUND OF INVENTION

1. Field of the Invention

The present invention relates to a projection apparatus, and more particularly to a fixing structure for a light valve use in the projection apparatus.

2. Description of the Prior Art

Referring to FIG. 1 and FIG. 2, a fixing structure 10 for a light valve 11 of the prior art is installed inside the projection apparatus (Not shown in drawing). The light valve 11 (e.g. a digital micro-mirror device, DMD) has an incidence surface 111 and a connection surface 112. Firstly, the incidence surface 111 of the light valve 11 is faced to a base plate 1 and placed on the base plate 1 of the projection apparatus. Then, a connector 12 having a conducting pin 121 horizontally adheres to the connection surface 112 of the light valve 11. Furthermore, a printed circuit broad 13 adheres to a surface 121 of the connector 12 having the conducting pin as electrical connection. Finally, a fixing device 14 is screwed from the outside of the printed circuit broad 13 to the base plate 1. Therefore, the light valve 11 is pressed by the base plate 1 and the printed circuit broad 13 to completely assemble the light valve 11.

As using the projection apparatus, for voltage switch or over heat of system, the electrical devices upon the printed circuit broad 13 are often broken, and need to repair or change. Referring to FIG. 1, the fixing structure 10 for light valve 10 utilizes a single fixing structure (which means the fixing device 14) by pressing way to fix the light valve 11 and the printed circuit broad 13 together. Thus, as screwing off the fixing device 14 to disassemble the printed electrical broad 13, the pressing pressure disappeared, so that the printed circuit broad 13 and the light valve 11 are disassembled at the same time. Meanwhile, hands or dust easily pollutes the disassembling light valve 11 causing the damage. As a result, the efficiency of the light valve could be affected.

In addition, the light valve 11 modulates and projects the light beams provided from a light system into a projection lens so that forms the images on a screen. For a rear projection system, the light beams being reflected from the projection lens still needs to reflect by reflection mirrors and forms the images on a screen. Therefore, when assembling a projection apparatus, the light system, the projection lens, the light valve, reflection mirrors, and the screen need to properly adjust to make the light beams precisely projected on the screen. Hence, when disassembling the printed circuit broad 13 of the fixing structure 10 of the prior art, the light valve 11 is disassembled at the same time. The relative position of the light valve and the optical devices (e.g. integration rod, lens) is moved and affects the focus of the light path and projection apparatus efficiency. For assuring the optimum projection performance, it needs to take time to adjust the light path.

### SUMMARY OF INVENTION

An object of the present invention is to provide a fixing structure for a light valve, which uses the individually fixing structures for the light valve and the printed circuit broad to conveniently dismantle the printed circuit broad and not to affect the performance of the projection apparatus.

To achieve the above and other objects, the present invention is a fixing structure for a light valve comprising a light valve, a connector, and a printed circuit broad. The light valve is installed on a projection apparatus having a container. The around of the container erects three positioning rods to form a plane surface, and the light valve can be positioned on the plane surface. The connector has an elastic deformable frame to form a cavity. The light valve is mounted and stuck inside the cavity. The outer surface of the connector has a fixing cavity and places a fixing piece to press and fix the connector on the container. The outer surface of the connector has positioning rods in accordance with the positioning holes of the printed circuit broad has positioning holes. The procedures of assembling the light valve includes inserting the light valve into the connector, fixing the connector to the container utilizing the fixing plates or adhesive, connecting the printed circuit broad near the connector, and, finally, fixing the printed circuit broad to the projection apparatus.

### BRIEF DESCRIPTION OF DRAWINGS

The above and other objects, advantages, and features of the present invention will be understood from the following detailed description of the invention when considered in connection with the accompanying drawings below.

FIG. 1 is an explored view showing a fixing structure for a light valve of the prior art.

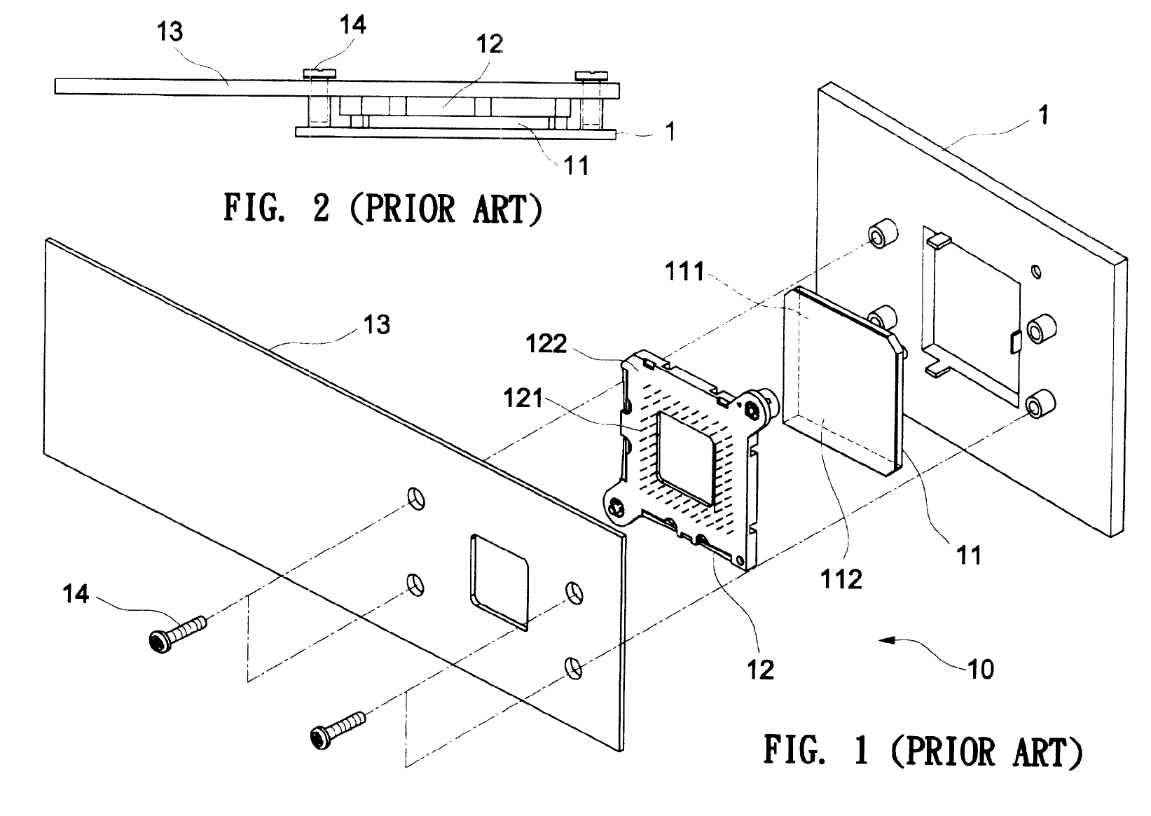

FIG. 2 is a side view showing a fixing structure for a light valve of the prior art.

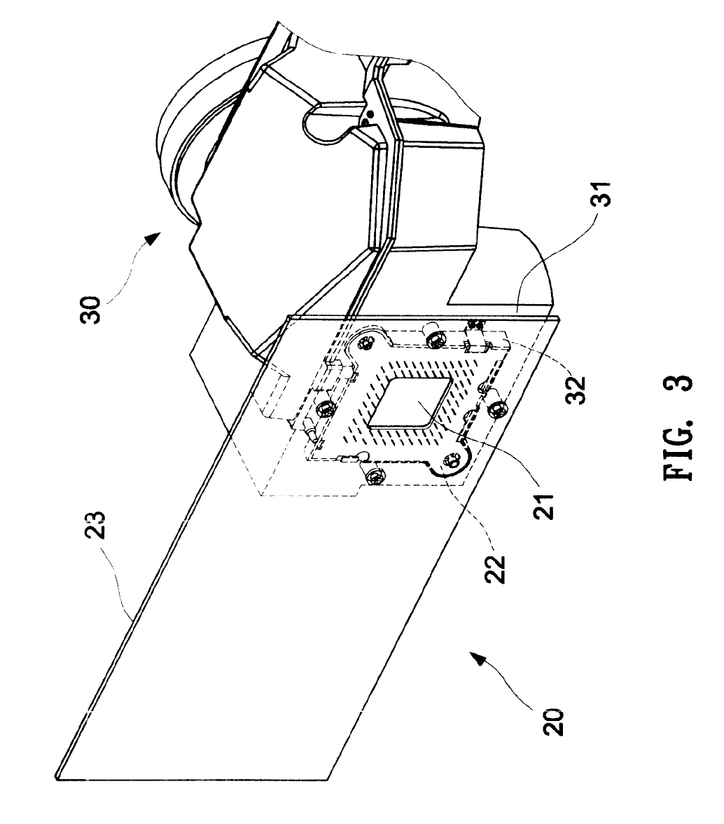

FIG. 3 is a perspective view showing a fixing structure for a light valve of the present invention.

FIG. 4A, FIG. 4B, and FIG. 4C are explored views showing fixing structures for a light valve of the present invention.

FIG. 5A and FIG. 5B is an assembling view showing using a screwing way of a fixing structure for a light valve of the present invention.

FIG. 6A and FIG. 6B is an assembling view using an adhesive way of a fixing structure for a light valve of the present invention.

FIG. 7 is an explored view showing the assembly of a cooling fan and a fixing structure for a light valve of the present invention.

### DETAILED DESCRIPTION

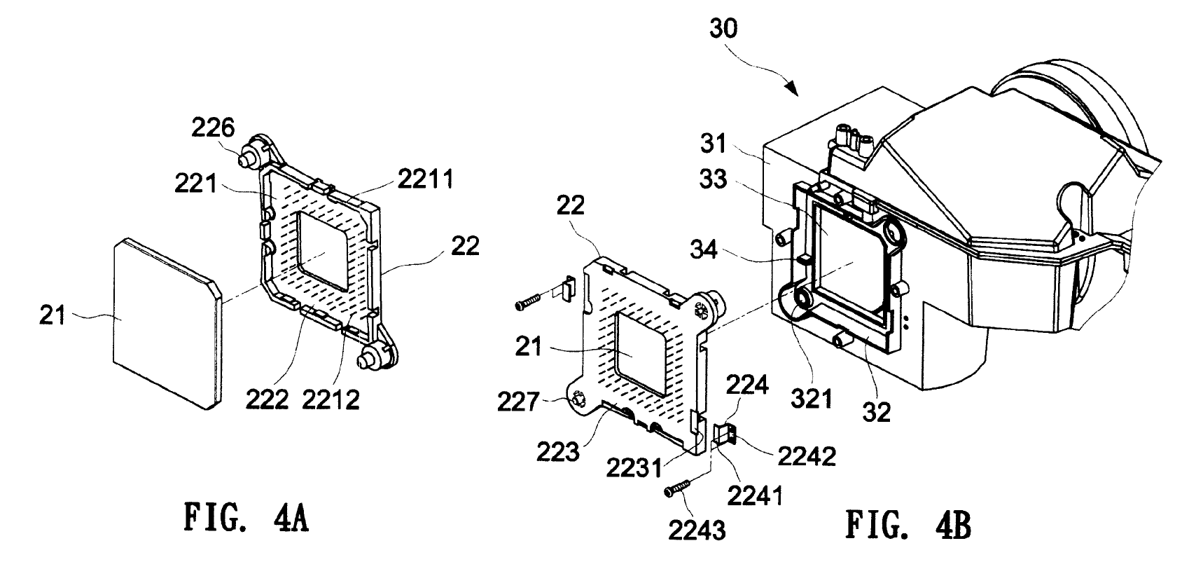

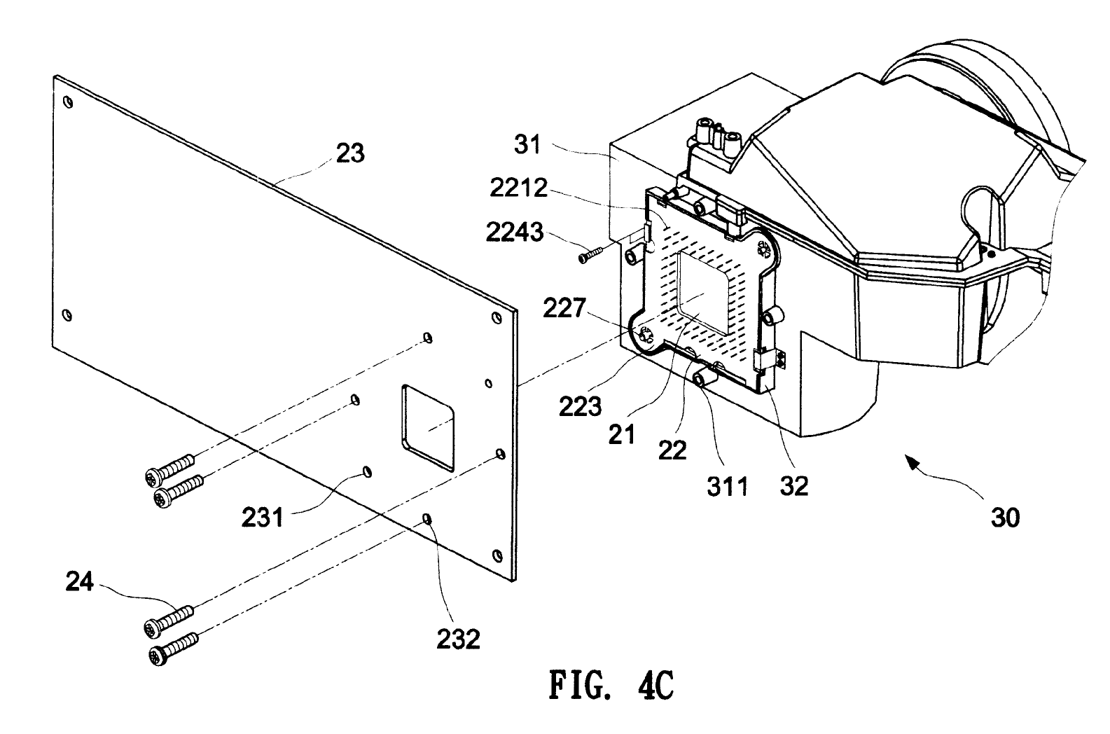

Referring to FIG. 3, a fixing structure 20 of the present invention is placed upon a projection apparatus 30. The projection apparatus 30 has a base plate 31 and forms a container 32. The fixing structure 20 comprises a light valve 21, a connector 22, and a printed circuit broad 23. Referring FIG. 4A to FIG. 4C, the light valve 21 could be a digital micro-mirror device (DMD), which is mounted inside the connector 22. The connector 22 is fixed in the container 32, and the printed circuit broad 23 is adhered to the connector 22 for electrical connection and screwed upon a base plate 31 to assemble the fixing structure 20 for the light valve 21.

Referring to FIG. 4B, the light valve 21 is placed inside the container 32 of the projection apparatus 30. The bottom of the container 32 has a window 33 for the light beams to impinge onto the light valve 21. The around of the windows 33 erects three positioning rods 34 to form a plane surface, and the light valve 2l can be positioned on the plane surface.

Referring to FIGS. 4A and 4B, the connector 22 is fixed upon the container 32 and has an elastic deformable frame 2211 to form a cavity 221. The light valve 21 is mounted inside the cavity 221. The bottom of the cavity 221 has a plurality of conducting pins 2212 which pass through an inner surface 222 and an outer surface 223. One surface of the light valve 21 is adhered to the inner surface 222 of the connector 22. The diagonal ends of the surface of the connector 22 facing the container 32 have positioning rods 226, and the inside of the container 32 has positioning holes 321 in accordance to the positioning rods 226 for positioning the connector 22 inside the container 32. In addition, the outer surface 223 of the connector 22 has a plurality of positioning rods 227.

The relative sides of the outer surface 223 of the connector 22 have a fixing cavity 2231 and a fixing piece 224. Two edges of the fixing pieces 224 have an upper fixing piece 2241 and a lower fixing piece 2242. The lower fixing piece 2242 is screwed upon the base plate 31 of the projection apparatus 30 by a screwing device 2243. The upper fixing piece 2241 is pressed and contained within the fixing cavity 2231 to press and fix the connector 22. By means of the fixing cavity 2231, the printed circuit broad 23 can adhere to the conducting pins 2212 of the outer surface 223 of the connector 22.

Referring to FIG. 4C, the printed circuit broad 23 is adhered to the outer surface 223 of the connector 22 for the electrical connection between the light valve 21 and the printed circuit broad 23 by the conducting pins 2212. The printed circuit broad 23 has the positioning holes 231 according to the position of the positioning rods 227 for assembly and positioning the circuit broad 23. In addition, the circuit broad 23 has a plurality of openings 232.

The fabricating procedures are shown in FIG. 3, FIG. 4A, FIG. 4B, and FIG. 4C. Firstly, the light valve 21 is mounted inside the connector 22 and, then, the connector 22 is putted in the container 32. By screwing or adhering to fix the connector 22, the circuit broad 23 is adhered to the outer surface 223 of the connector 22. Furthermore, by means of the screwing devices 24 pass through the openings 23 of the circuit broad 23 into fixing openings 311 of the base plate 31, the circuit broad 23 is fixed to the base plate 31 to assemble the fixing structure 20 for the light valve 21 upon the projection apparatus 30.

The fixing structure 20 of the present invention uses the individually fixing structures for the light valve 21 and circuit broad 23. It means that the light valve 21 is fixed by means of the connector 22 and container 32 to combine with the projection apparatus 30. The printed circuit broad 23 is fixed by means of the screwing devices 24 directly screwing upon the projection apparatus 30. As disassembling the printed circuit broad 23, the screwing devices 24 are screwed off to dismantle the printed circuit broad 23. It won't dismantle or removes the light valve 21. Therefore, the light valve 21 can avoid damage or pollution to maintain the relative position of the light valve 21 in the light path and projection performance.

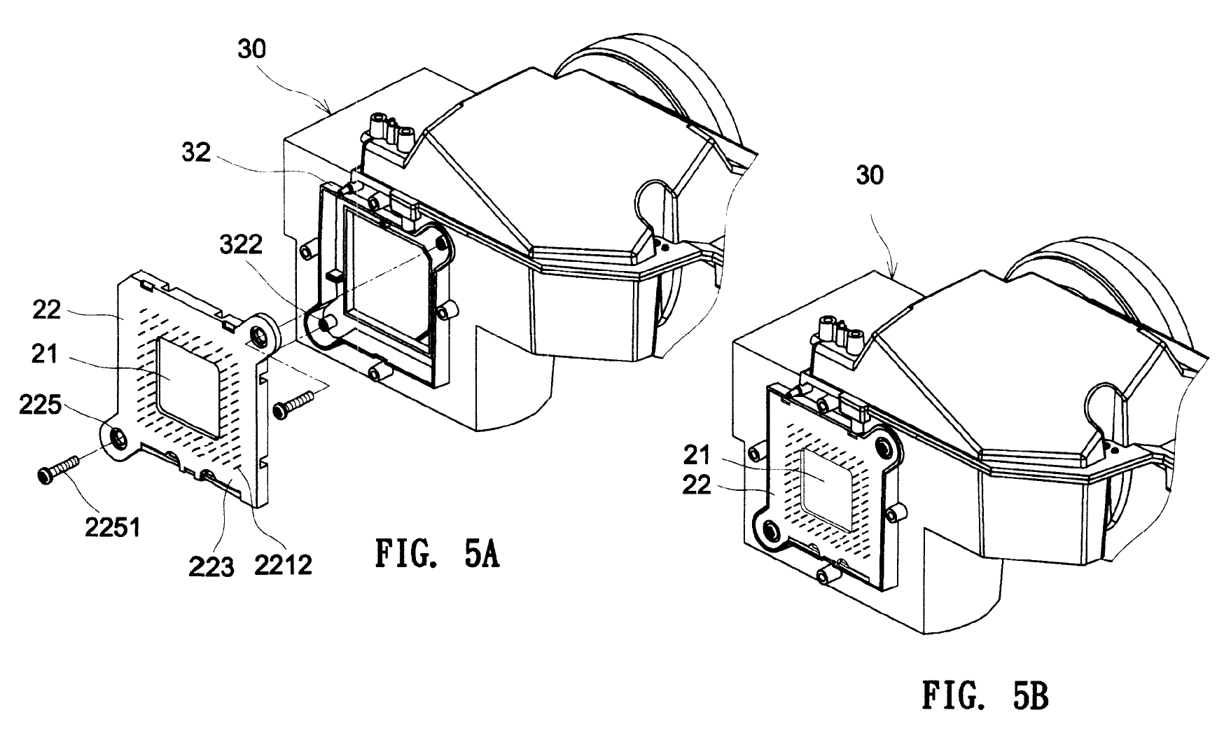

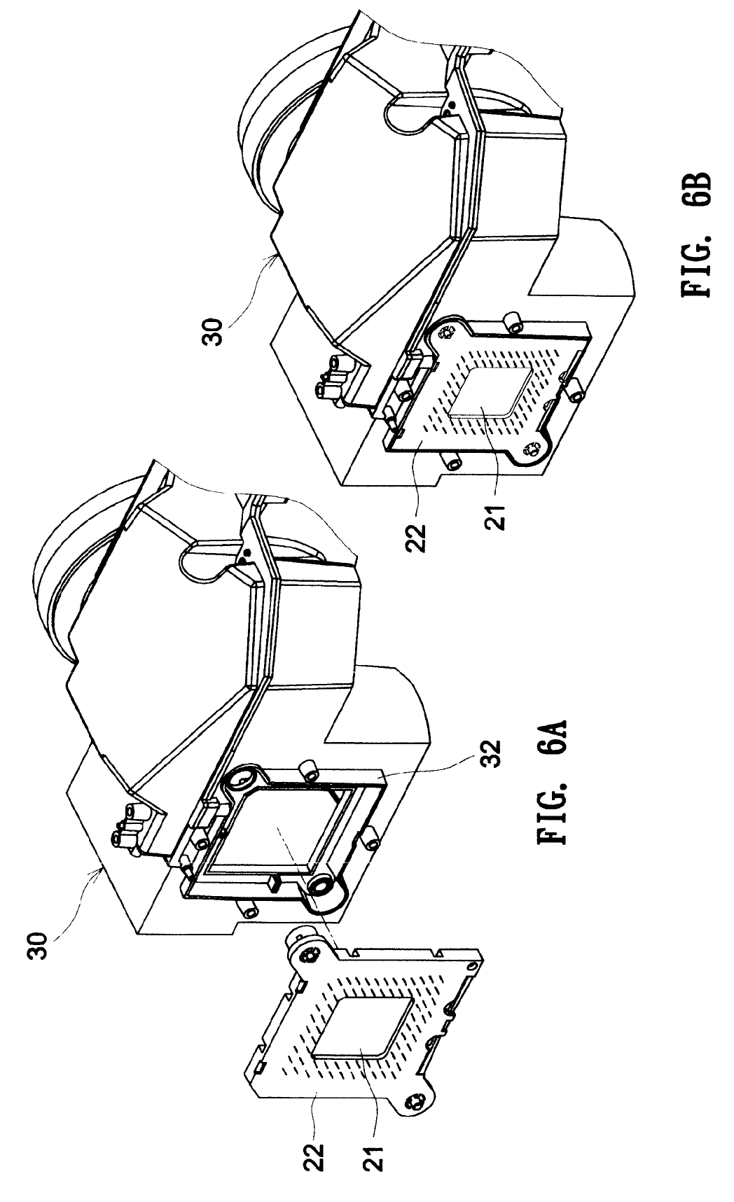

In addition, the connector 22 and the container 32 of the present invention can be directly screwed by the screwing devices or adhered to fix. The screwing step is shown as FIG. 5A and FIG. 5B. The container 32 and the connector 22 respectively have screwing opening 322 and countersunk openings 255 according to the position of each other. By means of a plurality of screwing devices 2251, which pass through the countersunk openings 255 and screw into the screwing openings 322, the connector 22 is connected and fixed with the container 32. The screwing devices 2251 are screwed into the countersunk openings 255 to prevent hindering the printed circuit broad 23 stuck on the conducting pins 2212 of the outer surface 223 of the connector 22. Referring to FIG. 6A and FIG. 6B, the adhering step is directly uses an adhesive in the contacting sides of the connector 22 and the container 32 to connect and fix the connector 22 with the container 32.

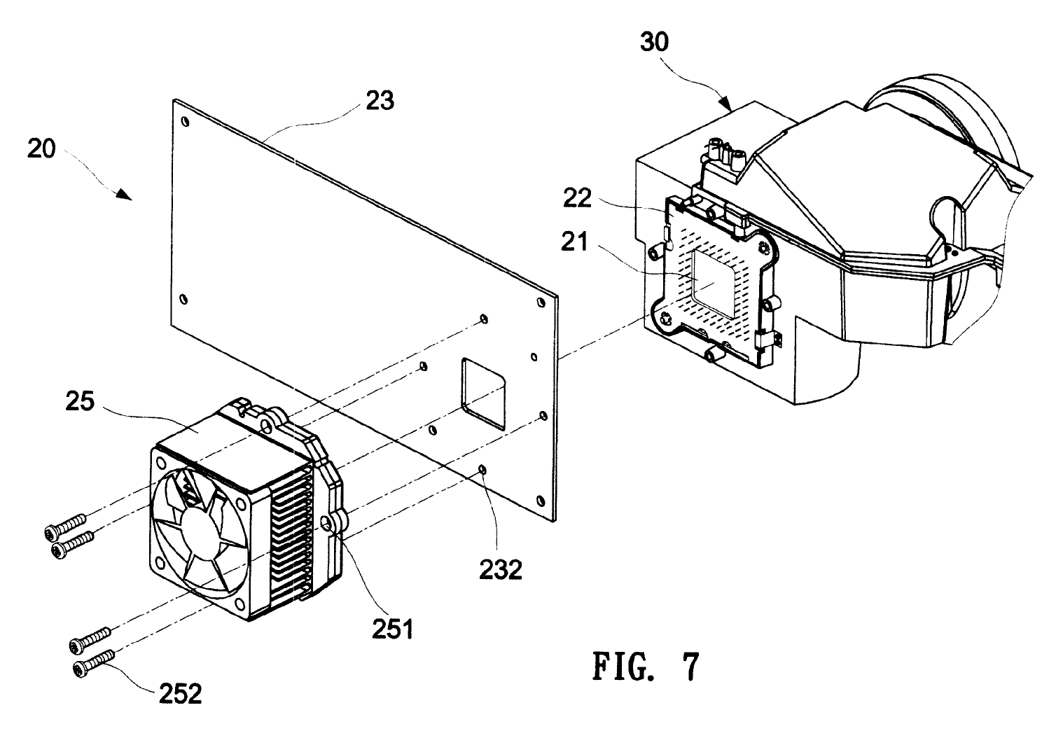

Furthermore, referring to FIG. 7, the outside of the printed circuit broad 23 has a cooling fan 25. The cooling fan 25 has a plurality of openings 251 in accordance with the positions of the openings 232 of the printed circuit broad 23. A plurality of screwing devices 252 firstly pass through the openings 251 of the cooling fan 25 and the opening 232 of the printed circuit broad 23, and finally screw to the base plate 31 of the projection apparatus 30 to form the independent-assembly cooling apparatus for light valve 21 of the fixing structure 20 for light valve. Therefore, as disassembling the fixing structure 20 for repairing a cooling apparatus, the projection performance of the light valve 21 isnt affected.

It will be apparent to those skilled in the art that in light of the forgoing disclosure, many alternations and modifications are possible in the practice of this invention without departing from the spirit or scoop thereof. Accordingly, the scoop of the invention is to be considered in accordance with the substance defined in the following claims.

1. A fixing structure for a light valve, comprising:
a light valve which is placed inside a container of a projection apparatus;
a connector fixed in said container to fix said light valve, which has one inner surface being stuck to a surface of said light valve; and
a circuit broad which is stuck to a outer surface of said connector and screwed on said projection apparatus by means of screwing devices.

2. The fixing structure for a light valve according to claim 1, wherein said connector has a plurality of conducting pins which pass through said inner surface and said outer surface.

3. The fixing structure for light valve according to claim 1, wherein the bottom of said container erects three positioning rods to form a plane for positioning said light valve.

4. The fixing structure for light valve according to claim 1, wherein said connector has a cavity which is formed by an elastic frame, said light valve being mounted inside said cavity.

5. The fixing structure for light valve according to claim 1, wherein said inner surface and said outer surface are provided for electrical connection.

6. The fixing structure for light valve according to claim 1, wherein said outer surface has at least one fixing cavity and at least one fixing device which has one end pressing said fixing cavity and the other end screwing to said projection apparatus.

7. The fixing structure for light valve according to claim 1, wherein said connector is adhered and fixed to said container.

8. The fixing structure for light valve according to claim 1, wherein said connector is screwed to said container.

9. The fixing structure for light valve according to claim 1, wherein said light valve is digital micro-mirror device.

10. The fixing structure for light valve according to claim 1, wherein said circuit broad is a printed circuit broad.

11. The fixing structure for light valve according to claim 1, further comprising a cooling fan which is placed at the outside of said circuit broad, a plurality of screwing devices passing through said cooling fan and said circuit broad to screw to said projection apparatus.

12. The fixing structure for light valve according to claim 1, wherein said outer surface of said connector has at least one positioning rod, said circuit broad has at least one positioning hole in accordance with the position of said positioning rod.
